(19) United States
(12) Patent Application Publication
(10) Pub. No.: US 2009/0041554 A1
(43) Pub. Date: Feb. 12, 2009

(54) Chamfer drill

(76) Inventor: Hsu Hsiu-Kwei Liu, Taichung (TW)

Correspondence Address: TROXELL LAW OFFICE PLLC;SUITE 1404, 5205 LEESBURG PIKE, FALLS CHURCH, VA, 22041, US

(21) Appl. No.: 11/882,959

(22) Filed: Aug. 8, 2007

(51) Int. Cl. B23B 51/10

(52) U.S. Cl. 408/225

(57) ABSTRACT

A chamfer drill includes a chamfer bit, a sleeve having a unidirectional needle bearing and a strong magnet respectively fitted in a front and a rear end thereof, and a handle associated at a front bore with the rear end of the sleeve. The chamfer bit has a rearward extended shaft, which is extended into the sleeve through the unidirectional needle bearing to end closely in front of the magnet, and is therefore magnetically attracted to the magnet and fixedly located in the sleeve. When the chamfer bit has been turned once to chamfer a drilled hole, an operator can continue the chamfering simply by turning the chamfer bit reversely and then forward again without the need of extracting the chamber bit from the hole being chamfered. And, only one handle is needed for associating with differently sized chamfer bits.

### FIELD OF THE INVENTION

The present invention relates to a chamfer drill, and more particularly to a chamfer drill that can be operated with reduced time and labor, and manufactured at reduced cost.

### BACKGROUND OF THE INVENTION

FIG. 1 shows a conventional chamfer drill used to chamfer a drilled hole. As shown, the conventional chamfer drill includes a chamfer bit 1 fixedly associated with a handle 2 to form an integral body. To use the chamfer drill with this structure to chamfer a drilled hole, first turn the handle 2 and drive the chamfer bit 1 into the drilled hole, and then extract the chamfer bit 1 before turning the handle 2 to drive the chamfer bit 1 into the drilled hole again. The turning and driving and the extracting of the chamfer drill into and from the drilled hole must be repeated until the drilled hole is satisfactorily chamfered. Therefore, a lot of time and labor is consumed to complete the hole chamfering operation. Moreover, since the chamfer bit 1 is fixedly connected to the handle 2, a lot of chamfer drills each having a handle 2 and a chamfer bit 1 of a particular size must be prepared for use in chamfering differently sized drilled holes. As a result, manufacturing and purchasing costs and storing space for the conventional chamfer drills are increased. It is therefore tried by the inventor to develop an improved chamfer drill to overcome the drawbacks in the conventional chamfer drill.

### SUMMARY OF THE INVENTION

A primary object of the present invention is to provide an improved chamfer drill, which allows an operator to chamfer a drilled hole with reduced time and labor by turning a chamfer bit thereof rightward and leftward without the need of extracting the chamfer bit from the drilled hole each time the chamfer bit has been turned rightward.

Another object of the present invention is to provide an improved chamfer drill, which allows the use of only one handle for associating with differently sized chamfer bits, so that the chamfer drill may be produced at reduced cost and does not occupy a large storage space.

To achieve the above and other objects, the chamfer drill according to the present invention includes a chamfer bit, a sleeve having a unidirectional needle bearing and a strong magnet respectively fitted in a front neck portion and a rear end thereof, and a handle associated at a front bore with the rear end of the sleeve. The chamfer bit has a rearward extended shaft, which is adapted to extend into the sleeve through the unidirectional needle bearing to end closely in front of the magnet, and is therefore magnetically attracted to the magnet and fixedly located in the sleeve. When the chamfer drill used to chamfer a drilled hole is turned rightward, the shaft of the chamfer bit is pressed against the bearing to perform one cutting stroke. And, when the chamfer drill is turned leftward, the chamfer bit idles. In this manner, each time the chamfer drill has been turned rightward to chamfer the hole, an operator needs not to extract the chamfer bit but only to turn the chamfer bit leftward and then rightward again to continue the hole chamfering. And, since the shaft of the chamber bit is magnetically attracted to the strong magnet to fixedly fit in the sleeve, the chamfer bit may be easily replaced, and only one handle is needed for associating with differently sized chamfer bits.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a plan view of a conventional chamfer drill;

FIG. 2 is an exploded perspective view of a chamfer drill according to the present invention;

FIG. 3 is an assembled view of FIG. 2;

FIG. 4 is a longitudinal sectional view of FIG. 3; and

FIG. 5 is a longitudinal sectional view showing the chamfer drill of the present invention with another differently sized chamfer bit mounted thereon.

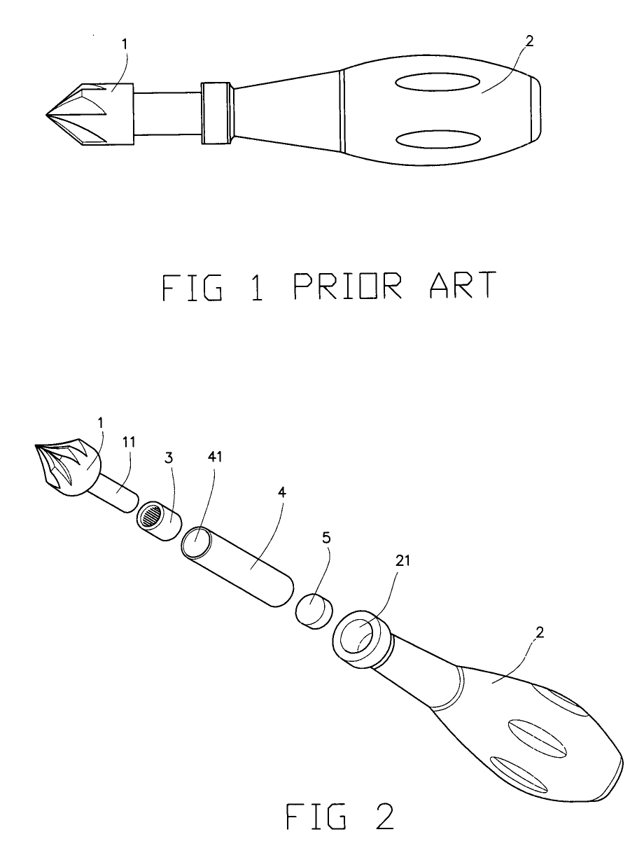

### DETAILED DESCRIPTION OF THE PREFERRED EMBODIMENTS

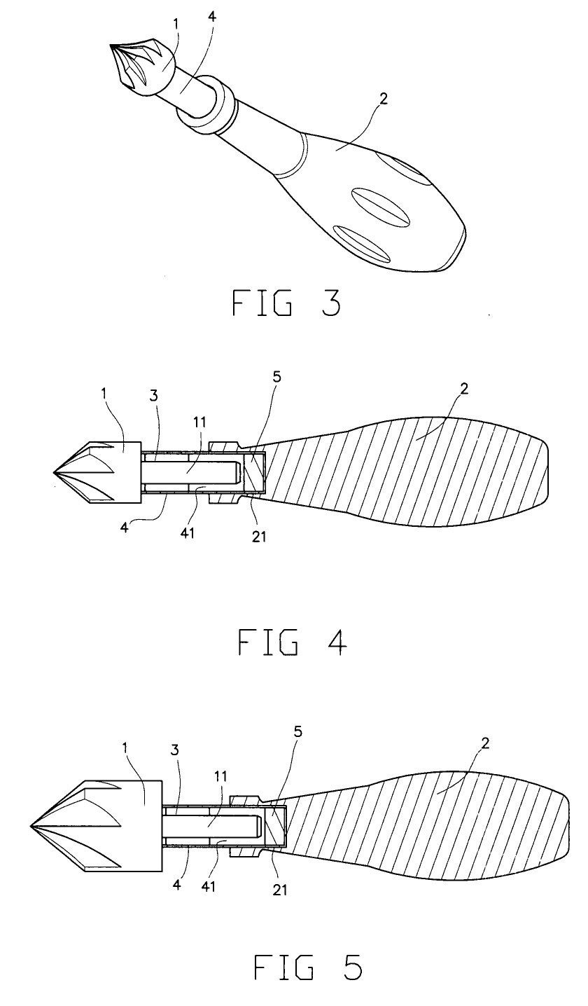

Please refer to FIGS. 2 and 3, which are exploded and assembled perspective views, respectively, of a chamfer drill according to the present invention. As shown, the chamfer drill of the present invention includes a chamfer bit 1, a handle 2, a unidirectional needle bearing 3, a sleeve 4, and a strong magnet 5.

The sleeve 4 defines a bore 41. The strong magnet 5 is fitted in the bore 41 to locate at a rear end of the sleeve 4. The bearing 3 is also fitted in the bore 41 to locate at a front neck portion of the sleeve 4. The sleeve 4 is connected to the handle 2 by fixedly fitting the rear end of the sleeve 4 in an axial bore 21 formed in a neck portion at a front end of the handle 2. The chamfer bit 1 has a rearward extended shaft 11, which is adapted to extend through a bore of the unidirectional needle bearing 3 to end at a position in the bore 41 of the sleeve 4 closely in front of the strong magnet 5, so that a rear end of the shaft 11 is magnetically firmly attracted to the strong magnet 5. An outer circumferential surface of the shaft 11 extended through the bearing 3 is in contact with needles on the bearing 3. When the handle 2, and accordingly the shaft 11, are right-hand turned, the outer circumferential surface of the shaft 11 is pressed against the needles on the unidirectional needle bearing 3, bringing the bearing 3 to turn and move forward along with the shaft 11 and accordingly, the chamfer bit 1. And, when the handle 2 is left-hand turned, only the shaft 11 and accordingly, the chamfer bit 1 are brought to idle.

Please refer to FIG. 4 that is a longitudinal sectional view of the chamfer drill of the present invention. When the chamfer drill of the present invention is fully assembled and used to chamfer a drilled hole, the shaft 11 turned rightward is tightly pressed against the unidirectional needle bearing 3, bringing the bearing 3 to turn and move forward along with the shaft 11 while the chamfer bit 1 performs one cutting stroke. On the other hand, when the shaft 11 is turned leftward, it idles along the needles of the unidirectional needle bearing 3.

With these arrangements, an operator needs not to extract the chamfer drill from the hole being chamfered each time the latter has been turned rightward to move forward for chamfering. The operator needs only to directly turn the chamfer drill leftward and then rightward again. In this manner, the hole chamfering could be completed with reduced time and labor.

Since the strong magnet 5 is fitted in the bore 41 to locate at the rear end of the sleeve 4, the magnet 5 is able to magnetically attract the shaft 11 extended into the bore 41 to aid in the positioning of the shaft 11 in the sleeve 4. Therefore, when the handle 2 is rightward turned, the chamfer bit 1 is brought to turn via the shaft 11 magnetically attracted to the magnet 5.

With the strong magnet 5 disposed in the bore 41 of the sleeve 4, the shaft 11 rearward extended from the chamfer bit 1 may be extended into and extracted from the bore 41 of the sleeve 4 at any time. Therefore, it is very easy to replace a chamfer bit 1 having a smaller size with another chamfer bit having a larger size as necessary. That is, only one handle 2 is needed for associating with separate differently sized chamfer bits 1. In this manner, the chamfer drill can be produced and supplied at reduced cost, and less storage space is needed for the chamfer drill.

What is claimed is:

1. A chamfer drill, comprising a chamfer bit, a unidirectional needle bearing, a sleeve, a strong magnet, and a handle.

2. The chamfer drill as claimed in claim 1, wherein the sleeve defines a bore, and the strong magnet is fixedly fitted in the bore to locate at a rear end of the sleeve.

3. The chamfer drill as claimed in claim 1, wherein the unidirectional needle bearing is fitted in the bore of the sleeve to locate at a neck portion at a front end of the sleeve.

4. The chamfer drill as claimed in claim 1, wherein the sleeve is connected to the handle by fitting the rear end of the sleeve in an axially extended bore formed in a front neck portion of the handle.

5. The chamfer drill as claimed in claim 1, wherein the chamfer bit includes a rearward extended shaft;
the shaft being extended through a bore of the unidirectional needle bearing to end at a position in the sleeve closely in front of the strong magnet.
